(19) United States
(12) Patent Application Publication
(10) Pub. No.: US 2016/0236613 A1
(43) Pub. Date: Aug. 18, 2016

(54) COVERING DEVICE, SYSTEM, BODY COMPONENT, BODY COMPONENT SYSTEM, AND VEHICLE

(71) Applicant: KUNSTSTOFF-TECHNIK SCHERER & TRIER GMBH & CO KG, Michelau (DE)

(72) Inventor: Martin Trier, Michelau-Neuensee (DE)

(21) Appl. No.: 15/023,197

(22) PCT Filed: Sep. 18, 2014
(86) PCT No.: PCT/EP2014/069850

§ 371 Date: Mar. 18, 2016

(30) Foreign Application Priority Data
Sep. 19, 2013 (DE) 20 2013 008 321.2
Mar. 28, 2014 (DE) 20 2014 002 763.3

(51) Int. Cl. B60Q 1/26; B60R 13/04; B60Q 1/48

(52) U.S. Cl. CPC B60Q 1/2661; B60Q 1/482; B60R 13/04; B60Q 2400/00

(57) ABSTRACT

The invention relates to a covering device for at least partially covering a recess, a flat section, a curved section, and/or a stepped section of at least one body component and/or one vehicle element of a vehicle, wherein the covering device comprises a lighting device or can be coupled to a lighting device and wherein the covering device is designed in such a way that at least a section of the covering device can be shone through by means of the lighting device. The invention further relates to a system, comprising a covering device and a lighting device, and to a body component, to a body component system, and to a vehicle.

### FIELD OF THE INVENTION

The present invention relates to a covering device on at least one body component of a vehicle. The present invention relates further to a system comprising a covering device and a lighting device, to a body component and to a body component system, as well as to a vehicle.

### TECHNICAL BACKGROUND

Vehicles generally have as a covering device a roof strip which covers a gap between the roof of the vehicle and a side panel. Such covering strips are normally made of a plastics-metal composite.

### SUMMARY OF THE INVENTION

Against this background, the object underlying the invention is to provide an improved covering device for at least one body component of a vehicle.

According to the invention, the object is achieved by a covering device having the features of claim 1 and/or by a system having the features of claim 15 and/or by a body component having the features of claim 18 and/or by a body component system having the features of claims 21, 22 and 23 and/or by a vehicle having the features of claim 27.

According to the invention, there is provided a covering device for covering at least in part a recess, a flat portion, a curved portion and/or a stepped portion of at least one body component and/or a vehicle element of a vehicle, wherein the covering device has a lighting device or can be coupled to a lighting device and wherein the covering device is so designed that light from the lighting device can shine through at least a portion of the covering device.

In this manner, the outline or a portion of the outline of the vehicle can be illuminated and can serve as position lighting, so that a driver is more easily able to locate the vehicle, for example at night on an unlit car park. The lighting of the covering device is switched on, for example, when the vehicle is opened by means of a car key having a transmitter. Hitherto in the prior art, only the headlamps were illuminated or a beep was sounded, and thus the driver is now additionally able to locate his vehicle more easily by the illuminated covering device.

The finding/idea underlying the present invention consists in designing the hitherto existing covering device so that the position of a vehicle can be determined in the dark. According to the invention, the covering device is so designed that light can shine through and thus it lights up on the outside in the dark.

As a result of the illuminated design of the covering device, better recognition of the vehicle in particular in the dark or in diffuse lighting conditions can be achieved, in order, for example, to make the vehicle easier to locate, to permit better visibility in the case of a breakdown and/or to prevent accidental damage to the vehicle by another vehicle when parking or passing in a narrow street, etc. In particular, in the case of a vehicle breakdown, for example, the illuminated covering device, which traces, for example, at least a portion of the vehicle outline, can make the vehicle and, for example, the physical dimensions thereof better discernible for other road users and thereby increase the safety of the occupant of the vehicle.

Advantageous embodiments and further developments of the invention will become apparent from the dependent claims and from the description with reference to the drawings.

In one embodiment of the invention, the covering device has a strip element. The strip element can be in the form of a functional element, for example an impact protection strip, roof rail, etc., or in the form of a decorative element, in particular a trim strip.

In another embodiment of the invention, the covering device or the strip element thereof has on at least one longitudinal side at least one lip element which is connected to the strip element. The lip element can rest on the body component in the fitted state or can form a defined gap therewith. The strip element and the at least one lip element can be integral, or the lip element can be fixed to the strip element as a separate part.

In one embodiment of the invention, the at least one lip element can be fixed to the strip element by extrusion, adhesive bonding, interlocking, injection moulding and/or clamping.

In a further embodiment of the invention, the strip element has a holder for receiving at least one fixing portion of the at least one lip element. The holder can be in the form of, for example, a groove with an undercut, into which the lip element with its fixing portion can be inserted.

According to one embodiment of the invention, the strip element and/or the at least one lip element are made of a material which is at least partially transparent, translucent or opaque so that light from the lighting device can shine through, wherein the strip element and/or the at least one lip element made of an opaque material has at least one opening for light from the lighting device to shine through. A strip element or lip element made of an at least partially transparent or translucent material has the advantage that it is able to cover the recess in the body component in such a manner that the recess is closed from the outside. An opaque strip element or opaque lip element having at least one opening for light to shine through in turn has the advantage that the strip element can be made of metal.

In another embodiment of the invention, the lighting device has at least one light source and/or at least one afterglow pigmentation or afterglow pigment which is mixed with the material of the covering device. An afterglow ink, afterglow foil or afterglow paint can likewise be applied to the front side or outside of the covering device, for example to the strip element and/or the at least one lip element. The afterglow pigment or afterglow pigmentation has the advantage that it is not necessary in this case to provide an additional light source, such as an LED or other lamp, in order to illuminate the covering device.

In one embodiment of the invention, the light source is, for example, a light-emitting diode, an organic light-emitting diode, an electroluminescent foil, a filament lamp or a laser. Light-emitting diodes have the advantage that they require little installation space, consume little energy and moreover also permit coloured illumination.

According to one embodiment of the invention, the covering device has at least one light guide, which is integrated into the covering device. At least one light guide can be integrated into the strip element and/or into the at least one lip element.

In one embodiment of the invention, the at least one light guide can be integrated into the covering device integrally or as a separate component. To that end, the at least one light guide can be extruded or injection moulded into the covering device and/or be arranged in at least one cavity in the covering device. For example, the at least one light guide can be introduced into a tubular cavity, which is open at least at one end, and the opening can then be closed if required.

According to another embodiment of the invention, the at least one light guide can be coupled to the at least one light source. The light guide is, for example, a light-guiding foil, a light-guiding fabric or an elongate light guide, for example a glass fibre or, in the case of a plurality of light guides, a glass fibre cable. By means of the light guide, light, for example, from a light source that is arranged at a distance from the covering device on the vehicle can be guided to the covering device and illuminate it.

In one embodiment of the invention, the covering device is a decorative element, for example a trim strip, such as a door trim strip, etc. To that end, the strip element, for example, can be made of metal and the lip element can have at least one light guide for illuminating the covering device. However, the covering device can likewise also additionally be in the form of a functional element, for example in the form of an impact protection strip. In this case, the strip element of the covering device, for example, can be formed with a reinforcing structure enabling the strip element additionally to act as an impact protector.

In one embodiment of the invention, a body component of a vehicle has at least one flat or planar portion, at least one curved portion, at least one stepped portion and/or a recess, wherein the at least one flat or planar portion, the at least one curved portion, the at least one stepped portion and/or the recess is or are provided with a covering device, wherein the covering device covers at least in part the at least one flat or planar portion, the at least one curved portion, the at least one stepped portion and/or the recess, for example joint or joint gap, on the outside and wherein light from the lighting device shines through or illuminates at least a portion of the covering device. The body component can be, for example, a roof panel, a wing panel, a door panel, a bonnet panel, a tailgate panel, a bumper panel, a rear apron panel, a front apron panel or a side panel of the vehicle.

According to a further embodiment of the invention, the lighting device is part of the body component, of the vehicle and/or part of the covering device. For example, a light guide of the covering device can be coupled to a light source of the vehicle in order to guide light from the light source to the covering device and to shine through the covering device.

In another embodiment of the invention, a body component system comprises a first and a second body component, wherein the first and the second body component together form a common recess, for example a joint or a joint gap, which is covered at least in part by a covering device, and wherein light from a lighting device shines through or illuminates at least a portion of the covering device. As a result, a covering device for covering a gap between a roof panel and a side panel of a vehicle, for example, can be illuminated.

In a further embodiment of the invention, a body component system comprises a body component and a vehicle element, wherein the body component and the vehicle element together form a common recess, in particular a joint or joint gap, wherein the recess is covered at least in part by at least one covering device and light from a lighting device shines through at least a portion of the covering device.

In yet a further embodiment of the invention, a body component system comprises a body component and a vehicle element, wherein the body component or the vehicle element has a recess, a flat portion, a curved portion and/or a stepped portion, wherein the recess, the flat portion, the curved portion and/or the stepped portion is covered at least in part by at least one covering device and light from a lighting device shines through or illuminates at least a portion of the covering device.

According to one embodiment of the invention, the vehicle element is a side window, a sunroof, a glass roof, a windscreen, a rear window, a radiator grill, a vehicle lamp, a vehicle mirror or a vehicle mirror casing.

According to one embodiment of the invention, the lighting device is part of at least one of the body components, of at least one vehicle element and/or part of the covering device.

In a further embodiment of the invention, a vehicle, in particular a motor vehicle, has a body component having a recess, which is covered by means of a covering device, and/or a body component system, wherein two body components of the body component system form a recess which is covered by means of a covering device, wherein in each case light from a lighting device shines through at least a portion of the covering device.

According to one embodiment of the invention, the covering device extends in the longitudinal direction of the vehicle or in the transverse direction of the vehicle along the recess in the body component or in the body component system. In this manner, for example, a recess running in the transverse direction of the vehicle in a roof panel can be covered by means of the covering device running along the recess and be shone through or illuminated on the outside by means of a lighting device. A recess between the roof panel and the side panel of the vehicle can likewise be covered by means of the covering device running along the recess and be shone through or illuminated on the outside by means of a lighting device. The covering device can extend from the A-pillar to a D-pillar of the vehicle.

In one embodiment of the invention, the covering device extends in the longitudinal direction of the vehicle and/or in the transverse direction of the vehicle along a recess in the first or second body component of the body component system or along a common recess of the first and second body components of the body component system. For example, the covering device can be arranged as a roof strip in a joint gap of the roof panel and a side panel.

In another embodiment of the invention, the covering device extends in the longitudinal direction of the vehicle and/or in the transverse direction of the vehicle along a recess in the body component or in the vehicle element of the body component system or extends along a common recess of the body component and of the vehicle element. For example, the covering device can be arranged in a recess in the roof panel or in a recess in the form of a joint gap between the roof panel and a sunroof or glass roof, circumferentially around the sunroof or glass roof.

The above embodiments and further developments can freely be combined with one another, where expedient. Further possible embodiments, developments and implementations of the invention also include combinations which have not explicitly been mentioned of the features of the invention described above or in the following in respect of the embodiments. In particular, a person skilled in the art will also add individual aspects as improvements or additions to the particular basic form of the present invention.

### BRIEF DESCRIPTION OF THE DRAWINGS

The present invention will be described in greater detail below with reference to the embodiments shown in the schematic drawings, in which:

FIG. 1 is a cutaway view of a portion of a body component and of a covering device according to an embodiment of the invention;

FIG. 2 is a cutaway view of a portion of two adjacent body components and of a covering device according to an embodiment of the invention;

FIG. 3 is a top view of a vehicle with different variants for the positioning of a covering device according to an embodiment of the invention;

FIG. 4 is a side view of the vehicle according to FIG. 3;

FIG. 5 is a cutaway view of a portion of two adjacent body components and of a covering device according to a further embodiment of the invention;

FIG. 6 is a cross-sectional view of a portion of a covering device with an integrated light guide;

FIG. 7 is a cross-sectional view of a portion of another covering device with an integrated light guide;

FIG. 8 is a cross-sectional view of a portion of a curved portion of a body component;

FIG. 9 is a cross-sectional view of a portion of a stepped portion of a body component;

FIG. 10 is a perspective view of a vehicle with different variants for the positioning of a covering device according to the invention;

FIG. 11 is a perspective view of a vehicle with further variants for the positioning of a covering device according to the invention;

FIG. 12 is a perspective view of a vehicle with yet further variants for the positioning of a covering device according to the invention; and

FIG. 13 is a perspective view of a vehicle with different variants for the positioning of a covering device according to the invention.

The accompanying drawings are intended to impart further understanding of the embodiments of the invention. They illustrate embodiments and, in conjunction with the description, serve to explain principles and concepts of the invention. Other embodiments and many of the mentioned advantages will become apparent from the drawings. The elements of the drawings are not necessarily shown to scale relative to one another.

In the drawings, elements, features and components which are the same, perform the same functions and have the same effects are provided with the same reference numerals, unless indicated otherwise.

### DESCRIPTION OF EMBODIMENTS

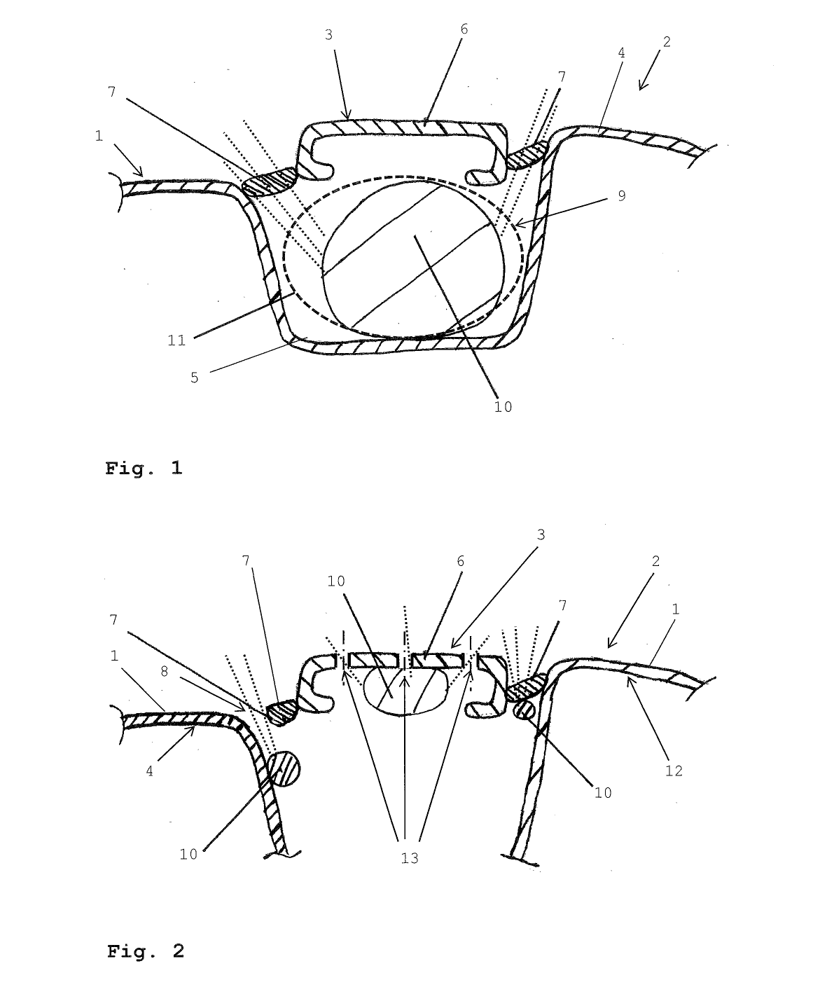

FIG. 1 is a highly simplified and purely schematic cross-sectional view of a first body component 1 of a vehicle 2, which is provided with a covering device 3 according to one embodiment of the invention. The fixing of such a covering device to the body component or body components is generally known and is not shown in FIG. 1 for reasons of clarity. The same applies to FIG. 2 below.

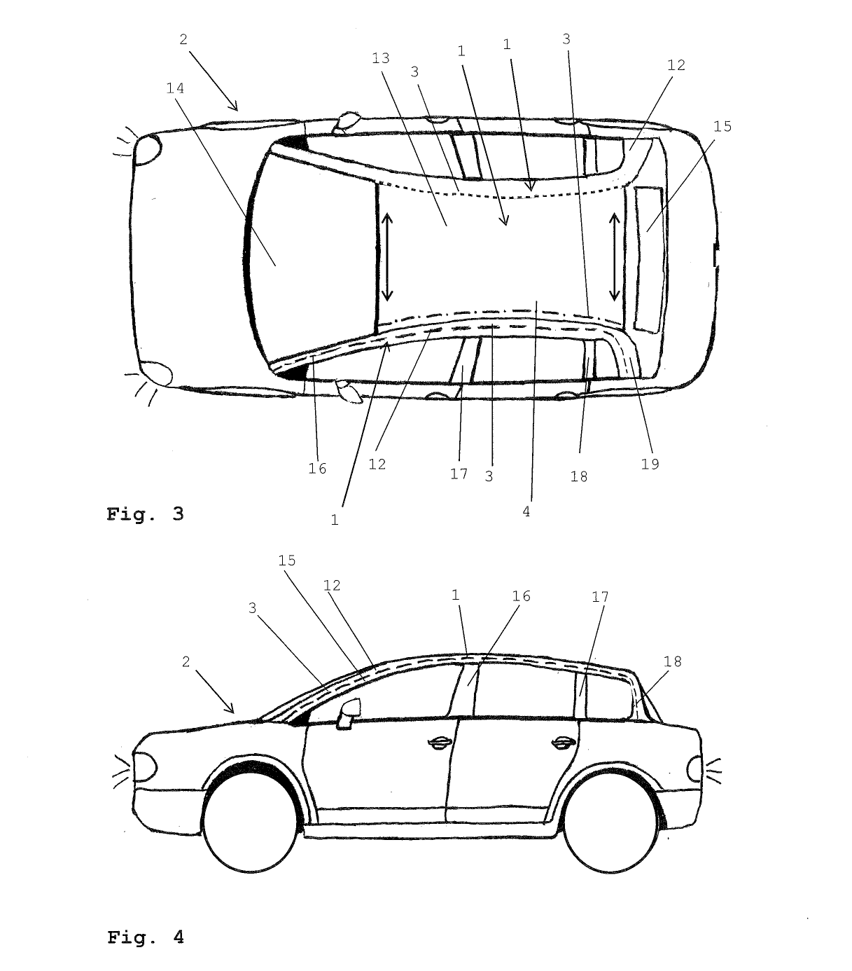

In the embodiment shown in FIG. 1, the body component 1 is a roof panel 4, but instead of a roof panel 4 it can likewise be a side panel or any other body component which can be provided with at least one covering device, as is indicated in FIGS. 3 and 4 below. The panels mentioned with reference to FIG. 1 and in FIG. 2-13 below, such as the side panel, door panel, tailgate panel, wing panel, bonnet panel, tailgate panel, front apron panel, rear apron panel, bumper panel, etc., can be metal panels but also, for example, plastics panels, fibre-reinforced plastics panels, etc. or a combination of metal, plastics and/or fibre-reinforced plastics panels, etc. The invention is not limited to metal, plastics and fibre-reinforced plastics panels and combinations thereof.

As is shown in the cutaway view in FIG. 1, the body component 1 has a recess 5, for example a joint as is shown in FIG. 1 or a gap as is shown in FIG. 2. The width of the gap 5 is covered at least in part or completely by the covering device 3. The covering device 3 has a strip element 6. The strip element 6 is connected on at least one side or, as is shown in the embodiment in FIG. 1, on both sides to at least one lip element 7. The lip element 7 is integral with the strip element 6 or is fixed thereto as a separate part. In the fitted state, the lip element 7 rests on the body component 1, as is shown in FIG. 1, or it forms a gap or joint gap with the body component 1, as is shown in the embodiment in FIG. 2.

The strip element 6 and/or at least one lip element 7 is or are designed so that light can shine through. To that end, the strip element 6 or the lip element 7 is transparent, partially transparent or translucent or alternatively is opaque and has at least one opening, as is shown in FIG. 2. The lip element 7 or the strip element 6 is made of a transparent, partially transparent or translucent material, for example a transparent, partially transparent or translucent plastics material. The strip element 6 and/or at least one lip element 7 can be produced from the at least partially transparent or translucent plastics material by means of extrusion, for example.

Provided that at least one opening is provided in the strip element 6 or lip element 7 for light to shine through, the strip element 6 or the lip element 7 can also be made of an opaque material, for example metal or an opaque plastics material, as is shown in the following embodiment in FIG. 2. Because light can shine through the covering device, it can serve, together with a lighting device, as position lighting, so that a driver is more easily able to locate the vehicle, for example at night on an unlit car park.

The covering device 3 further has a lighting device 9 or can be coupled to an already existing lighting device 9, for example. The lighting device 9 has at least one light source 10 and/or at least one afterglow pigment or phosphorescent pigment. Afterglow pigments or phosphorescent pigments glow after they have been irradiated with visible light. This property can be used to produce inks which glow in the dark, which must previously be charged by irradiation with light. For example, phosphorescent pigments based on alkaline earth aluminates, for example strontium aluminate, or zinc sulfide pigments can be used. Afterglow inks, afterglow paints, afterglow foils, etc. are produced using such afterglow pigments or phosphorescent pigments. The afterglow pigment or phosphorescent pigment can be mixed, for example, with the material for the strip element 6 or lip element 7.

It is likewise possible to use afterglow inks, afterglow foils or afterglow paints and to coat the strip element 6 and/or at least one lip element 7 therewith on its front side and/or outside.

The lighting device 9 can additionally have at least one light guide 11 for guiding the light of the at least one light source 9. The light guide 11 and the light source 9 are shown in highly simplified form in FIGS. 1 and 2.

The additional light guide 11 is shown in FIG. 1 by a broken line. As described above, the at least one afterglow pigment or phosphorescent pigment is introduced into the material for the lip element 7 or strip element 6, or the lip element 7 or strip element 6 is coated with, for example, an afterglow ink, an afterglow foil or an afterglow paint. However, the invention is not limited to afterglow inks, afterglow foils, afterglow paints or the mixing of afterglow pigments with the material of the covering device; these are merely examples for making the covering device phosphorescent. The afterglow pigment or phosphorescent pigment has the advantage that long-lasting illumination of the covering device 3 in the dark is possible without an additional light source, such as an LED.

The lighting device 9 can contain as the light source 10, for example, a light-emitting diode (LED), an organic light-emitting diode (OLED), an electroluminescent foil (EL foil), a filament lamp, a halogen lamp, a gas discharge lamp, a laser, etc. In addition to the mentioned examples of a light source 10, however, another light source, which is suitable for being integrated into a body component 1 and for shining through a covering device 3, can also be provided, the light source withstanding operation of the vehicle. The light source 10 can generate, for example, white light or coloured light, depending on the function and intended use. For example, coloured LEDs as light sources 10 allow the covering device 3 also to be illuminated in colour. This applies to all the embodiments of the invention.

As an additional light guide 11, the lighting device 9 can have, for example, a light-guiding foil, a light-guiding fabric or an elongate light guide. Where there is a plurality of light guides 11, they can be in the form of, for example, optical waveguides, fibre optic cables or glass fibre cables. Furthermore, the light guide 11 can be, for example, rigid or flexible. The invention is not limited to the mentioned examples of light guides 11.

The light source 10 and/or the light guide 11 can be integral with the strip element 6 and/or the lip element 7 or can be coupled thereto as a separate component, as is shown in the embodiment in FIG. 1.

As is shown in FIG. 1, the light source 10 is arranged in the recess 5, in this case the joint, in the body component 1 on the rear side of the strip element 6 and the two lip elements 7. In the embodiment shown in FIG. 1, the two lip elements 7 are, for example, transparent, whereas the strip element 6 is opaque. In the embodiment in FIG. 1, the strip element 6 is, for example, a metal strip to which the two transparent lip elements 7 of plastics material are fixed. The lip elements 7 are fixed to the strip element 6, for example injection moulded, interlocked, clamped, inserted, introduced, screwed, bolted, riveted and/or adhesively bonded, etc. The invention is not limited to the mentioned fixing methods for fixing a lip element 7 to the strip element 6. Any other fixing method which is suitable for fixing the lip element 7 to the strip element 6 can be used.

For example, the strip element 6, for example in the form of a metal strip, can be in the form of an extruded aluminium section with inserted lip elements 7. The strip element 7 can likewise be an injection moulded part or an extruded part. Furthermore, the strip element 6 and the respective lip element 7 can also be formed in one piece, for example from plastics material.

In the embodiment shown in FIG. 1, the light source 10 shines through the transparent lip elements 7. Direct illumination, in this case of the lip elements 7, can thus be provided by means of the light source 10. The light beams of the light source 10 which have passed through the lip elements 7 to the outside are indicated in FIG. 1 by a dotted line. Where an additional light guide 11 is provided, as is indicated by a broken line in FIG. 1, indirect illumination can also be provided, in this case of the lip elements 7, by guiding the light from the light source 10 through the light guide 11 to the lip elements 7. As a result, it is also possible, for example, to illuminate lip elements 7 which are situated at a distance from the light source 10.

One or more additional openings, for example slots, through which the light of the light source 10 can pass, can optionally be provided in the opaque strip element 6, as is shown in FIG. 2. In this manner, in addition to shining through the transparent lip elements 7, light from the lighting device 10 can also shine through the otherwise opaque strip element 6 in the embodiment in FIG. 1. The opaque strip element can likewise be coated on its outside with an afterglow ink, an afterglow foil or an afterglow paint.

As described above, the light source 10 and/or the light guide 11 can also be fixed to the strip element 6 or the lip element 7, as is indicated in FIG. 2, or can be integral therewith. As a result, the covering device 3 can be pre-assembled with the light source 10 and optionally the additional light guide 11 and fitted as a system.

In the case where the covering device 3 is coupled to a separate light source 10 and/or a separate light guide 11, as is shown in FIG. 1, an existing light source 10 and/or light guide 11, for example, can be retrofitted with the covering device 3.

FIG. 2 is a highly simplified and purely schematic cutaway view of two body components 1 of a vehicle 2 which are provided with a covering device 3 according to one embodiment of the invention. One body component 1 in the embodiment shown in FIG. 2 is a roof panel 4 and the other body component 1 is a side panel 12. The covering device 3 can accordingly be provided, as is shown in FIG. 3, between the roof panel 4 and the side panel 12 of a vehicle 2 and can extend, for example, from the windscreen to the rear window or from the A-pillar to a B-pillar, a C-pillar or to a D-pillar of a vehicle.

However, instead of the combination of a roof panel 4 and a side panel 12, any other combination of body components 1 which can be provided with at least one covering device 3 can also be provided.

The embodiment shown in FIG. 2 corresponds substantially to the embodiment of the invention shown in FIG. 1, so that reference is made in this connection to the statements made with reference to FIG. 1, in order to avoid unnecessary repetition. The embodiment shown in FIG. 2 differs from the embodiment shown in FIG. 1 substantially in that the recess 5 which is covered by means of the covering device 3 is formed by two body components 1 in FIG. 2 instead of by one body component 1 in FIG. 1. The recess in FIG. 2 is in the form of, for example, a gap between the two body components in FIG. 2.

Furthermore, the covering device 3 in the embodiment in FIG. 2 forms in the fitted state a gap 8 or joint gap between one of the lip elements 7 and the associated body component 1, which gap is illuminated by a light source 10. Moreover, in the embodiment in FIG. 2, a further light source 10 is attached to the strip element 6 and a further light source 10 is attached to a lip element 7. Furthermore, the strip element 6 in the embodiment in FIG. 2 has a plurality of additional openings 13 for light to shine through. The light beams which have passed from the light sources 10 through the lip elements 7, the gap 8 and the openings 13 to the outside are indicated in FIG. 2 by a dotted line.

As described above with reference to FIG. 1, at least one part of the covering device 3, that is to say at least the strip element 6 and/or at least one lip element 7, is so designed that it can be illuminated. For the purpose of illumination, the strip element 6 and/or at least one lip element 7 are made of an at least partially transparent or translucent material and are optionally additionally provided with at least one afterglow pigment or phosphorescent pigment. Likewise, for the purpose of illumination, the strip element 6 and/or the at least one lip element 7 can also be made of an opaque material and be provided with at least one opening 13 for light to shine through, as is shown in FIG. 2.

In the embodiment shown in FIG. 2, one lip element 7 rests in the fitted state on one body component 1, while the other lip element 7 forms a gap 8 or joint gap with the other body component 1. A light source 10 is arranged in the recess 5 formed by the two body components 1 and is optionally additionally fixed, for example adhesively bonded, etc., therein. The light source 10 shines through the gap 8 between the body component 1 and the lip element 7 to the outside. The lip element 7 is opaque. However, it can in principle also be made of an at least partially transparent or translucent material or can be omitted altogether.

Furthermore, there is provided on the rear side of the other lip element 7 a light source 10 or at least one light guide (not shown) connected to a light source, for shining light through the at least partially transparent or translucent lip element 7. There may optionally additionally be provided at least one light guide which guides the light of the light source 10 in the longitudinal direction of the lip element 7 in order, for example, to illuminate or shine through regions of the lip element 7 that are at a distance from the light source 10. Instead of being made of an at least partially transparent or translucent material, the lip element 7 can also be made of an opaque material, for example an opaque plastics material. In order to be illuminated or for light to shine through, the lip element 7 in this case has at least one opening (not shown).

Furthermore, as is shown in the embodiment in FIG. 2, a light source 10 or at least one light guide (not shown) connected to a light source can be provided on the rear side of the strip element 6, for illuminating the strip element 6. In the embodiment in FIG. 2, the strip element 6 is made, for example, of an opaque material, for example in the form of an extruded metal profile. For illuminating the strip element 6, the strip element 6 has at least one opening or, as shown in FIG. 2, a plurality of openings 13 for light to shine through.

In the embodiment in FIG. 2, the light source 10 and/or the at least one light guide are fixed to the associated strip element 6 or to the associated lip element 7, for example by adhesive bonding, etc. Adhesive bonding is, however, merely an example of a large number of fixing methods for fixing the light source 10 or the light guide to the covering device 3. The invention is not limited to the mentioned example. Any other fixing method can be used for fixing the light source 10 or the light guide to the covering device 3. Furthermore, the light source 10 or the light guide, if they are already present, for example, can also be coupled to the covering device 3, as is shown in FIG. 1 and for one lip element 7 in FIG. 2.

FIG. 3 is a top view of a vehicle 2 with different variants for the positioning of a covering device 3 according to one embodiment of the invention. The diagram in FIG. 3 is highly simplified and purely schematic. The variants show in particular possibilities for illuminating the outline of the vehicle by means of the illuminated covering device and, for example, facilitating the location of a parked vehicle in the dark.

As has been described above with reference to the embodiment of FIG. 1, a covering device 3 can be arranged in a recess or joint in a body component 1 and can have a lighting device or be coupled to a lighting device.

In a first variant, the covering device 3 can be provided in the roof panel 4 as a body component 1 for covering a recess in the roof panel 4. The run of the covering device 3 in the recess in the roof panel 4 is indicated in FIG. 3 by a dot-and-dash line and shown above in the embodiment in FIG. 1. The covering device 3 runs in the longitudinal direction of the roof panel 4 along the recess and can extend over at least part of the length or over the entire length of the roof panel 4, as is indicated in FIG. 3. A covering device (not shown) can likewise extend also in the transverse direction of the roof panel 4 along a recess, for example over at least part of the width or over the entire width of the windscreen 14 or the rear window 15, as is indicated by double-headed arrows in FIG. 3.

In a second variant, the covering device 3 can be provided in a side panel 12 as a body component 1, for covering a recess in the side panel 12. The run of the covering device 3 in the recess in the side panel 12 is indicated in FIG. 3 by a broken line and is comparable to the embodiment as is shown in FIG. 1. The covering device 3 can extend over at least part of the length or over the entire length of the side panel 12 from the windscreen 14 to the rear window 16 or from the A-pillar 16 via the B-pillar 17 and the C-pillar 18 to the D-pillar 19 of the vehicle 2 and to the tailgate, as is shown in FIG. 3.

According to a third variant, the covering device 3 can be provided in a recess or gap between the roof panel 4 as a body component 1 and a side panel 12 as a further body component 1, for covering the recess or gap between the two body components 1. The run of the covering device 3 in the recess or gap between the roof panel 4 and the side panel 12 is indicated in FIG. 3 by a dotted line and is shown above in the embodiment in FIG. 2.

The covering device 3 can extend, for example, along at least part of the length or over the entire length of the roof panel 4, as is shown in the embodiment in FIG. 3, or of the side panel 12.

The invention is not limited to the three variants shown for body components 1 for providing with the covering device 3. Furthermore, instead of one covering device 3, it is also possible to provide at least two successive covering devices. Likewise, a covering device 3 can have along its length, on at least one side, at least two successive lip elements instead of a continuous lip element. This applies to all the embodiments of the invention.

FIG. 4 is a side view of the vehicle 2 according to FIG. 3. FIG. 4 shows the run of the covering device 3 along the recess in the side panel 12 by a broken line. The covering device 3 runs in FIG. 4 from the A-pillar 16 via the B-pillar 17 and the C-pillar 18 to the D-pillar 19 of the vehicle 2. The covering device 3 can extend over the length of the D-pillar to the tailgate.

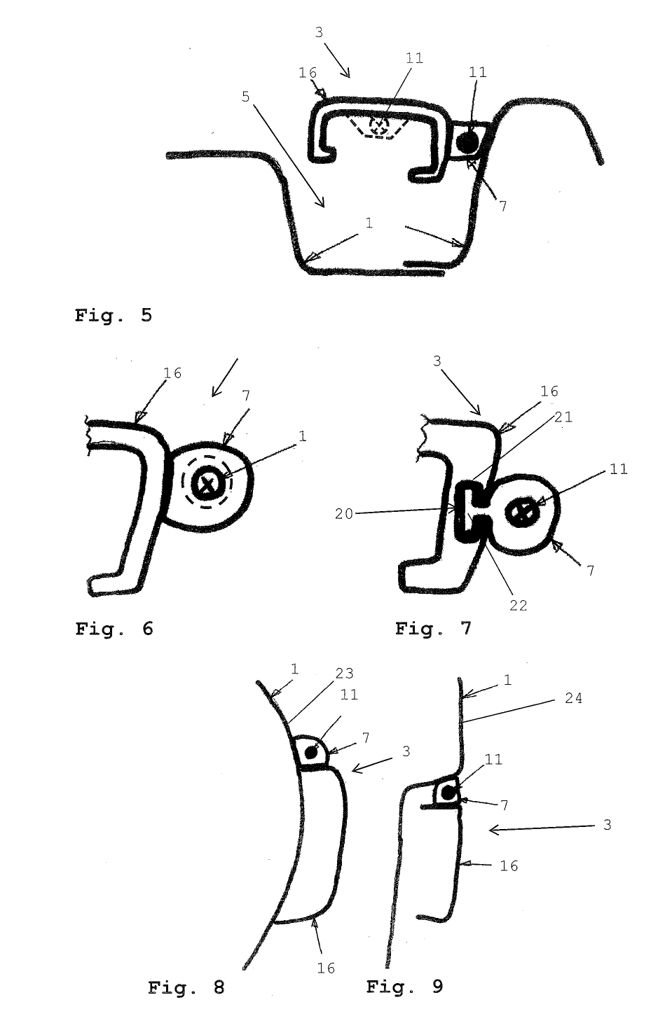

FIG. 5 is a highly simplified and purely schematic cutaway view of a portion of two adjacent body components 1 and a covering device 3 according to a further embodiment of the invention. The embodiment according to FIG. 5 has substantially the same construction as the embodiments described above with reference to FIG. 1-4, so that reference is made in this connection to the description of FIG. 1-4, in order to avoid unnecessary repetition.

In the embodiment shown in FIG. 5, at least one light guide 11 is integrated into the covering device 3 and is, for example, integral or formed in one piece with the covering device 3, as has been described above as a variant with reference to FIG. 1.

Instead of the one light guide 11, a plurality of light guides 11 can likewise be integrated into the covering device 3. In FIG. 5 and in FIG. 6-13 below there is used as the light guide 11 in particular an elongate light guide 11, for example a glass fibre or, where there are a plurality of light guides 11, a glass fibre cable. In principle, however, a light-guiding foil and/or a light-guiding fabric, for example, can also be provided as the light guide 11.

The at least one light guide 11 of the covering device 3 in FIG. 5 is, as in FIG. 6-13 below, coupled to at least one lighting device 9, for example a lighting device 9 that is already present in a vehicle. In addition or alternatively, the covering device 3 can have at least one lighting device 9 of its own which is coupled to the at least one light guide 11.

The lighting device 9 has at least one light source 10 and/or at least one afterglow pigment, phosphorescent pigment and/or fluorescent pigment, as has already been described above. This applies to all the embodiments of the invention. As described above, the light source 10 can be, for example, at least one light-emitting diode (LED), an organic light-emitting diode (OLED), an electroluminescent foil (EL foil), a filament lamp, a halogen lamp, a gas discharge lamp and/or a laser, etc.

In the embodiment shown in FIG. 5, the at least one light guide 11 is, for example, integrated into at least one lip element 7 of the covering device 3 on one side of the covering device 3.

In addition or alternatively, at least one light guide 11 can likewise also be integrated into the strip element 6, as is indicated in FIG. 5 by a broken line. In this case, the at least one lip element 7 may also be omitted or left out if required. This applies to all the embodiments of the invention.

The lip element 7 and/or the strip element 6 in FIG. 5, and in FIG. 6-13 below, can be made entirely of an at least partially transparent or translucent material, for example at least one at least partially transparent or translucent plastics material, in which the at least one light guide 11 is integrated. The at least partially transparent or translucent material may optionally additionally be coloured at least in one region or completely, in order to provide coloured lighting or illumination of the covering device 3 in that region. In addition or alternatively, the at least partially transparent or translucent material can optionally also additionally be provided with a coloured coating which light can shine through or with a coloured foil which light can shine through. The partially transparent or translucent material can, for example, be such that it is visually non-transparent but light can shine through, so that the covering device can outwardly light up in colour in the region of the partially transparent or translucent material. In addition or alternatively, a coloured light source 10 can likewise be used, for example a coloured LED, for example a red, green or blue LED, etc. This applies to all the embodiments of the invention.

Alternatively, the lip element 7 and/or the strip element 6 can be made of an opaque material, for example at least one opaque plastics material and/or metal, etc., and at least in the region of the at least one light guide 11 can be made of an at least partially transparent or translucent material, for example at least one at least partially transparent or translucent plastics material. The at least partially transparent or translucent material can thereby additionally be coloured, provided with a coloured foil, coated with a coloured layer which light can shine through and/or illuminated by means of at least one coloured light source, as described above, in order to provide coloured illumination of the covering device 3. This applies to all the embodiments of the invention.

The light guide 11 can, for example, be extruded or injection moulded into the lip element 7 and/or the strip element 6 and/or inserted or threaded into a cavity in the lip element 7 and/or strip element 6, as is indicated for the lip element 7 by way of example in FIG. 6 by means of a broken line.

In the embodiment in FIG. 5, the covering device 3 with the at least one light guide 11 integrated into the covering device 3 is arranged between two adjacent body components 1, for example a roof panel 4 and the side panel 12. The two adjacent body components 1 form a recess 5, for example a gap or joint gap, which is covered at least in part by the covering device 3 in the fitted state.

In the embodiment in FIG. 5, the at least one lip element 7 on one side of the covering device 3 rests on the opposite body component 1. The lip element 7 can likewise form a gap or joint gap with the body component 1, as is shown above in the embodiment in FIG. 2.

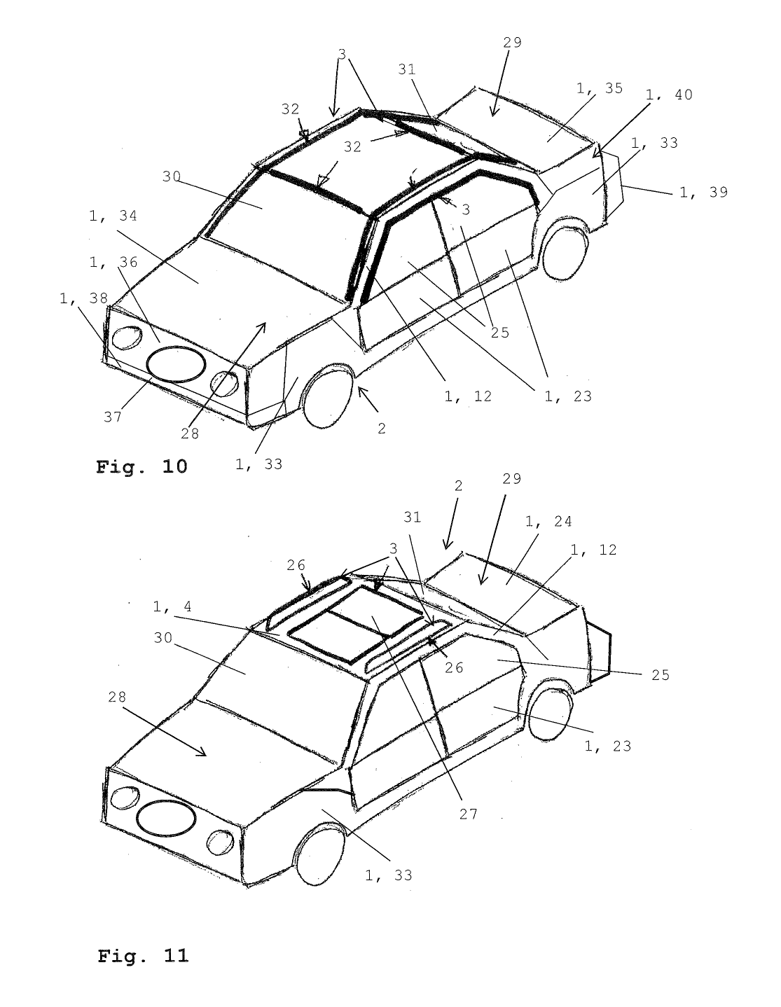

Instead of being arranged in a recess 5 between two adjacent body components 1, the covering device 3 with the at least one light guide 11 integrated into the covering device 3 can also be provided in a recess 5 in a body component 1, such as, for example, a roof channel of a roof panel 4, for covering the recess 5 at least in part in the fitted state, as is shown above by way of example in FIG. 2. Moreover, the covering device 3 with the at least one integrated light guide 11 can also be provided on a flat, curved or stepped region of a body component, as is shown by way of example in FIGS. 8 and 9 below, in order to illuminate that region.

FIG. 6 is a highly simplified and purely schematic cross-sectional view of a portion of a covering device 3 with at least one light guide 11 integrated therein.

In the embodiment shown in FIG. 6, the covering device 3 is, for example, formed in one piece or integral with the at least one light guide 11.

The strip element 6 and the at least one lip element 7 are thereby in the form of, for example, an extruded part made from at least one plastics material. The at least one light guide 11 is extruded into the lip element 7 in FIG. 1. The at least one light guide 11 or at least one further additional light guide 11 can likewise also be extruded into the strip element 6 (not shown).

As is indicated by a broken line in FIG. 6, the lip element 7 can also have, for example, a tubular cavity in its longitudinal direction, into which the at least one light guide 11 is inserted. The cavity is open, for example, at least at one end or at both ends of the lip element 7 and, if required, can be closed by means of a closing element (not shown), for example a rubber stopper, etc.

Instead of being integral or formed in one piece with the lip element 7, the at least one light guide 11 can also be integral or formed in one piece with the strip element 6 of the covering device 3 and, for example, be extruded into the strip element.

In a further embodiment, which is not shown, at least one light guide is integrated in at least one lip element 7 and at least one light guide is integrated in the strip element 6. The respective light guide is, for example, extruded into the lip element 7 and/or the strip element 6.

FIG. 7 is a highly simplified and purely schematic cross-sectional view of a portion of another covering device 3 with a light guide 11 integrated therein. The at least one light guide 11 is, for example, integrated into the lip element 7 of the covering device 3, for example extruded into the lip element, inserted into a cavity in the lip element, etc.

Furthermore, in the embodiment shown in FIG. 7, the lip element 7 is fixed as a separate part to the strip element 6. As a result, the lip element 7 and the strip element 6 can not only be made of the same material or of the same material combination but can also very easily be made of different materials or different material combinations. Depending on whether the at least one light guide 11 is integrated into the lip element 7 or into the strip element 6, that part can be made, for example, of plastics material and the other part, which does not have an integrated light guide, can be made, for example, of metal, for example in the form of a metal sheet or a cast metal part, etc., of rubber and/or of a different plastics material, etc.

The strip element 6 has a holder 20 for receiving and holding a fixing portion 22 of the lip element 7. As is shown in FIG. 7, the holder 20 is, for example, in the form of a groove 21 with an undercut. The groove 21 with the undercut extends, for example, in the longitudinal direction of the strip element 6 in FIG. 7 and is open at least at one end for the introduction or insertion of the fixing portion 22 of the lip element 7.

In the embodiment as is shown in FIG. 7, the groove 21 has a square cross section for receiving the corresponding fixing portion 22, which likewise has a square cross section. The groove 21, and accordingly the fixing portion 22 of the lip element 7, can have any desired cross section, for example a round, oval and/or angular cross section, etc.

The holder 20 of the strip element 6 and the fixing portion 22 of the lip element 7 can likewise also be of such a form that the lip element 7 can be engaged and/or clamped in the holder 20 with its fixing portion 22. This applies to all the embodiments of the invention.

In addition or alternatively to the fixing possibilities mentioned above, the lip element 7 can also be in such a form that it can be adhesively bonded, screwed, bolted, welded, etc. to the strip element 6. This likewise applies to all the embodiments of the invention.

FIG. 8 is a highly simplified and purely schematic cross-sectional view of a portion of an arrangement of a covering device 3 according to the invention on a curved portion of a body component 1. The body component 1 in the embodiment in FIG. 8 is, for example, a door panel 23. In the case of the door panel 23, the covering device 3 can, if required, be provided as or have the form of an impact protector or impact protection element. To that end, the strip element 6 of the covering device 3 can be formed, for example, with a reinforcing structure, suitable dimensions, a suitable material or material combination, etc. The impact protection element thereby forms a functional element.

The covering device 3 is fixed to the curved portion of the body component 1 in a conventional manner generally known to a person skilled in the art. The fixing of the covering device 3 is not shown for reasons of clarity. In the embodiment shown in FIG. 8, at least one additional lip element 7 is optionally provided on the strip element 6 of the covering device 3 on at least one side. The at least one lip element 7 is fixed, for example moulded, to the strip element, as has been described above, for example, with reference to FIG. 6, or is fixed to the strip element 6 as a separate component, as has been described above, for example, with reference to FIG. 7.

In the embodiment in FIG. 8, the at least one light guide 11 is integrated in, for example extruded into, the lip element 7. The at least one light guide 11 or at least one further additional light guide 11 can likewise also be integrated in, for example, extruded into, etc., the strip element 6.

In the embodiment in FIG. 8, the lip element 7 is so provided that it rests on the body component 1. The lip element with the light guide 11 integrated therein can likewise also form a gap with the body component 1, according to the function and intended use.

Furthermore, instead of being provided on a curved portion, the covering device 3 described with reference to FIG. 8 can also correspondingly be provided on a flat or planar portion of a body component 1. This applies to all the embodiments of the invention.

FIG. 9 is a highly simplified and purely schematic cross-sectional view of an arrangement of a covering device 3 according to the invention on a stepped portion of a body component 1. The body component 1 having the stepped portion is, for example, a tailgate panel 24.

The covering device 3 is thereby in the form of, for example, an illuminated handle strip, as is indicated in FIG. 9. The fixing of the covering device 3 to the tailgate panel is not shown in FIG. 9 for reasons of clarity. The fixing of such covering devices 3 is, however, generally known to a person skilled in the art.

The covering device 3 can likewise also be arranged between a handle strip and the stepped tailgate panel 24 or between the stepped tailgate panel 24 and a vehicle number plate (not shown). However, the invention is not limited to the examples mentioned. Examples of the arrangement of a covering device 3 according to the invention on various body components 1 having, for example, curved portions, stepped portions, gaps, recesses, etc. are shown in FIGS. 10 to 13 below.

As above in FIG. 8, for example, the covering device 3 in FIG. 9 has a strip element 6 which is attached to the stepped portion of the body component 1 in a conventional manner generally known to a person skilled in the art. On at least one side of the strip element 6, for example opposite a step of the body component 1, at least one additional lip element 7 is optionally provided and moulded onto the strip element, for example, as shown above in FIGS. 6 and 8, for example. The lip element 7 can likewise also be provided as a separate component fixed to the strip element 6, as shown above in FIG. 7, for example.

In the embodiment in FIG. 9, at least one light guide 11 is integrated in, for example extruded into, the lip element 7. The at least one light guide 11 or at least one further additional light guide 11 can likewise also be integrated in the strip element 6, for example extruded or inserted into the lip element, as has been indicated above in FIG. 6 by means of a broken line. The lip element 7 can rest on the opposite body component 1 or can form a gap (not shown) therewith.

FIG. 10 is a highly simplified and purely schematic perspective view of a vehicle with different variants for the positioning of a covering device 3 according to the invention. There is used thereby, for example, a covering device 3 with at least one integrated light guide, as has been described above by way of example with reference to FIG. 5-9. However, a covering device as described above with reference to FIG. 1-4 can likewise be used. This applies to all the embodiments of the invention and in particular to the following embodiments described with reference to FIG. 11-13.

In FIG. 10, in a first variant, a covering device 3 with at least one integrated light guide is provided, for example, as a decorative element in the form of a roof strip or as a functional element in the form of a protective roof strip 32, for example in a recess in the roof panel 4 as an example of a body component 1. Such a first variant has been described above with reference to FIG. 3 and is indicated in FIG. 3 by means of a dot-and-dash line and also by means of double-headed arrows. The covering device 3 in the roof panel 4 can be provided in the longitudinal and/or transverse direction of the roof panel 4 in FIG. 10 and in particular circumferentially around a portion or the entirety of the roof panel 4. At least one covering device 3 is arranged along the recess in the roof panel 4. The covering device 3 runs along at least part of the length or along the entire length of the recess in the roof panel 4. In this manner it is possible, for example, to illuminate a portion or the entire outline of the roof panel 4 and, for example, to facilitate considerably the location of the vehicle in the dark, for example when a car park in which the vehicle is situated is viewed from above.

Instead of being provided on the roof panel 4, the covering device 3 in the form of a roof strip or protective roof strip 32 can additionally also be provided on a side panel 12 adjacent to the roof panel 4. The covering device can thereby likewise be received and fixed, for example, in a recess in the side panel 12, where present. In the fitted state, the covering device 3 can cover at least a portion of the recess.

The covering device 3 in the form of a roof strip or protective roof strip 32 can likewise also be provided in a transition region or joint gap between the roof panel 4 and the side panel 12, between the windscreen 30 and the side panel 12, and/or between the rear window 12 and the side panel 12. The covering device 3 can thereby be fixed to the roof panel 4, the side panel 12, the windscreen 30 and/or the rear window 31.

Instead of a continuous or one-piece side panel 12 which extends, for example, from the A-pillar to the B-, C- or D-pillar, a plurality of side panels 12 can likewise be provided, along which the at least one covering device 3 extends. This applies to all the embodiments of the invention.

In a further variant, the covering device 3 can be provided, for example, as a decorative element, for example a trim strip, in particular a rainwater trim strip, on the side panel 12 or the side panels 12 which form a side panel frame of the vehicle 2.

In a corresponding manner, the covering device 3 can also be provided as a decorative element, for example a trim strip, in particular a door trim strip, on the door panel 23 which forms a door frame of the vehicle 2. In particular, the covering device 3 with at least one integrated light guide can be provided, for example, in a transition region or joint gap between the door panel 23 and a side window 25 as a vehicle element. The covering device 3 is thereby fixed, for example, to the door panel 23. Furthermore, the covering device 23 can be arranged, for example, circumferentially around at least a portion or the entirety of the window opening on the door panel 23 and thus illuminate the outline of the side window of the vehicle, which likewise makes the vehicle easier to locate in the dark.

The covering device 3 can be fixed to the side panel 12, for example, as a rainwater trim strip and in a corresponding manner to the door panel 23, for example, as a door trim strip and can optionally additionally be received in a recess, where present, in the side panel 12 or door panel 23.

The strip element of the covering device 3 in the variants described above, and also in the variant yet to be described with reference to FIG. 11-13, can additionally have at least one additional lip element on at least one side. In the fitted state, the lip element can thereby cover or conceal, for example, a portion of the respective body component 4, of the windscreen 30 as a vehicle element, of the rear window 31 as a vehicle element, of a side window in the door, etc.

FIG. 11 is a perspective view of a vehicle 2 with further variants for the positioning of a covering device 3 according to the invention. In one variant, the covering device 3 with, for example, at least one integrated light guide is integrated in a roof rail 26. To that end, the covering device 3 is fixed to the roof rail 26 in the longitudinal direction. The roof rail 26 can optionally additionally be provided with a recess or step in the longitudinal direction, in which the covering device 3 can be received and which can be covered at least in part by the covering device 3. Likewise, in a further variant, the strip element 16 itself can serve as or be in the form of a roof rail 26. As described above, the at least one light guide can thereby be integrated into the strip element, for example moulded or extruded into the strip element or inserted into a cavity in the strip element, to mention only a few examples. The strip element can, if required, be provided on at least one side with at least one additional lip element or can also be without a lip element, depending on the function and intended use.

In another variant, the covering device 3 can be provided in a transition region or joint gap between the roof panel 4 as a body component 1 and a sunroof 27 or between the roof panel 4 and a glass roof (not shown). The covering device 3 can thereby be provided, for example, on the roof panel 4 and/or the sunroof 27 or on the roof panel 4 and/or the glass roof at least in the longitudinal direction and/or transverse direction and fixed to the roof panel 4 as a body component 1 and/or the sunroof 27 or to the roof panel 4 and/or the glass panel 4. The covering device 3 can thereby be arranged, for example, circumferentially around at least a portion or the entirety of a sunroof opening or around the glass roof. The sunroof and the glass roof each form vehicle elements.

The roof panel 4 can optionally have a recess in which the covering device 3 is received. The covering device 3 can cover the recess, for example, at least in part in the fitted state. The covering device 3 can additionally be arranged circumferentially around at least a portion of the sunroof 27 or glass roof.

By illuminating, for example, portions or regions of the vehicle roof and/or of a roof rail 26 etc., the vehicle can easily be located in the dark. This is advantageous in particular when the owner of the vehicle, for example, is looking down on his vehicle from an elevated position, for example from above onto a car park. In this manner, the vehicle owner can easily make out the vehicle 2. In particular, by illuminating at least portions of the vehicle outline by means of at least one covering device 3, a vehicle owner can easily tell whether the illuminated object is a vehicle, is his vehicle type, or is a completely different object. Furthermore, a portion of the vehicle roof, of the bonnet 28, of the windscreen 30, of the rear window 31 and/or of the tailgate 29, etc. that is illuminated by means of at least one covering device 3 enables the vehicle 2 to be more easily located from above by means of a rescue helicopter, for example in the case of an accident.

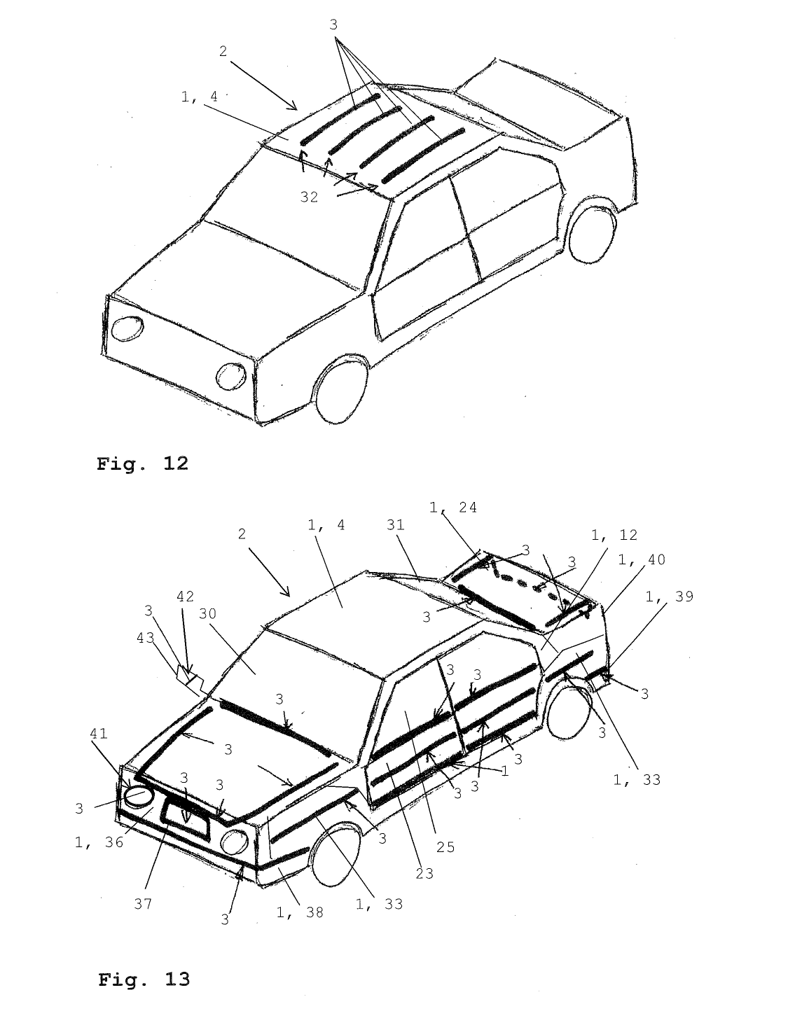

FIG. 12 is a perspective view of a vehicle 2 with yet a further variant for the positioning of a covering device 3 according to the invention. In one variant, the covering device 3 with, for example, at least one integrated light guide forms a protective roof strip 32 or is integrated into a protective roof strip. Such protective roof strips 32, as are shown in FIG. 12, are applied, for example, under roof racks for the purpose of protection.

In order to integrate the covering device 3 into the protective roof strip 32, the covering device 3 is fixed to the protective roof strip 32 in the longitudinal direction. The protective roof strip 32 can optionally additionally be provided with a recess or step in the longitudinal direction, in which the covering device 3 can be received. The recess or step can moreover be covered at least in part, for example, by the covering device 3 in the fitted state.

As described above, in a further variant, the strip element of the covering device 3 can itself function as or be in the form of a protective roof strip 32. As described above, the at least one light guide can thereby be integrated into the strip element, for example moulded or extruded into the strip element or inserted into a cavity in the strip element, etc.

Furthermore, the strip element in the mentioned variants can be without a lip element or, if required, can be provided with at least one additional lip element, depending on the function and intended use. At least one light guide can thereby be integrated into the lip element and/or at least one light guide can be integrated into the strip element. This applies to all the embodiments of the invention.

FIG. 13 is a further perspective view of a vehicle 2 with other variants for the positioning of a covering device 3 according to the invention.

A covering device 3 with at least one integrated light guide is provided in a window recess covering or a joint gap between the door panel 23 and the side window 25 of the vehicle 2. To that end, the covering device 3 is fixed, for example, to the door panel 23. In the case of a fixed side window (not shown), the rear window 31 or the windscreen 30 as vehicle elements, the covering device 3 can also additionally or solely be fixed to such a window. In the case of the upwardly and downwardly movable side windows 25 of the vehicle doors, on the other hand, a covering device 3 is preferably fixed only to the door panel 23.

The covering device 3 can further also be provided in a transition region or joint gap between the windscreen 30 as a vehicle element and the bonnet 28 as a body component 1. The covering device 3 can thereby be fixed to the bonnet 28 and/or to the windscreen 30. The bonnet 28 can optionally be provided with an additional recess for receiving the covering device 3, the covering device 3 covering the recess, for example, at least in part in the fitted state.

In a further variant, the covering device 3 can be provided in a transition region or joint gap between the rear window 31 and the tailgate 29 as a body component 1 and can thereby be fixed, for example, to the rear window 31 and/or to the tailgate 29. The tailgate 29 can optionally likewise be provided with an additional recess for receiving the covering device 3, the covering device 3 covering the recess, for example, at least in part in the fitted state.

According to a variant, the covering device 2 can be provided in a joint gap or lateral joint between the tailgate panel 24 and a side panel 12 or between the tailgate panel 24 and a wing panel 33. The covering device 3 can thereby be fixed, for example, to the tailgate panel 24 and/or the side panel 12 or correspondingly to the tailgate panel 24 and/or the wing panel 33. The covering device 3 can further also be received and fixed in a recess in the tailgate panel 24, the wing panel 33 or the side panel 12. The recess can be covered, for example, at least in part by the covering device 3 in the fitted state. The arrangement of a covering device 3 according to the invention in a recess has already been shown and described above, for example, in FIGS. 1, 2 and 5.

In a further variant, the covering device 3 can also be provided in a joint gap or lateral joint between the bonnet panel 34 and a side panel 12 or between the bonnet panel 34 and the wing panel 33. The covering device 3 can thereby be fixed, for example, to the bonnet panel 34 or the side panel 12 or the wing panel 33. The panel to which the covering device 3 is fixed can optionally additionally have a recess for receiving the covering device 3, the covering device 3 covering the recess, for example, at least in part in the fitted state.

In a variant, the covering device 3 can further be provided in a joint or a joint gap of the tailgate panel 35 as a body component 1 and fixed to the tailgate panel 35. The covering device 3 can likewise also be in the form of, for example, a decorative strip or handle strip of the body component 1, in this case, for example, of the tailgate panel 35, or can be integrated into the decorative strip or handle strip, as has been described above for an embodiment in FIG. 9.

As is shown in FIG. 13 in a further variant, the covering device 3 can also be provided in a joint, a front joint region or joint gap of the bonnet panel 34 and a front apron panel 36. As described above, the covering device 3 can be fixed, for example, to the bonnet panel 34 or the front apron panel 36 and can extend, for example, in the transverse direction or additionally also in the longitudinal direction of the bonnet or of the front apron.

Furthermore, in a variant in FIG. 13, the covering device 3 can also be provided in a transition region or joint gap between the front apron or the front apron panel 36 as a body component 1 and a radiator grill 37. The covering device 3 can thereby be provided circumferentially around at least a portion of the radiator grill 37 and can be fixed to the front apron panel 36 and/or to the radiator grill 37. The front apron panel 36 or the radiator grill 37 can optionally have a recess in which the covering device 3 is received. The covering device 3 can thereby cover the recess, for example, at least in part.

Moreover, in a further variant, the covering device 3 on the front or rear wing panel 33 as a body component 1 can be integrated, for example, into a decorative element, for example a trim strip, situated thereon. Likewise, the covering device 3 itself can be provided on and fixed to the front or rear wing panel 33 as an illuminated decorative element, for example an illuminated trim strip, in order to make the vehicle 2 easier to locate in the dark owing to the illuminated decorative element.

In another variant, the covering device 3 can be provided on the door panel 23, on a front bumper panel 38, on a rear bumper panel 39, on the front apron panel 36 or on the rear apron panel 40 as body components 1, in order to illuminate or light the body component 1 in question. In particular, the covering device 3 can be provided on the panel or body component 1 in question as a decorative trim or impact protection strip, as has been described above with reference to FIG. 8.

The covering device 3 is thereby in the form of an illuminated impact protection strip or trim strip on the body component 1 that is to be illuminated, or is integrated into such an impact protection strip or trim strip. The impact protection strip or trim strip can have a recess for receiving the covering device 3, which recess can be covered, for example, by the covering device 3 in the fitted state.

The covering device 3 can likewise also be provided, for example, in the joint or a joint gap between a vehicle lamp 41, for example the rear light or front light, and the rear apron panel 40 or rear bumper panel or the front apron panel 36 or the front bumper panel 38. By means of the covering device 3, the vehicle 2 can be illuminated in the region of the vehicle headlamps 41 even if the driver has not switched on the headlamps 41 themselves because, for example, he is not in the vehicle but is on the way to his vehicle. The covering device 3 can thereby be fixed to the vehicle headlamps 41 and/or to the body component 1.

In a further variant, the covering device 3 can also be provided on the vehicle mirror 42, for example in a joint or a joint gap between the casing 43 of the vehicle mirror 42 and the mirror, and can be fixed to the casing 43. Furthermore, the covering device 3 can also be fixed in any other position outside the casing 43 of the vehicle mirror 42. The vehicle mirror and the vehicle mirror casing form vehicle elements.

Illuminating the vehicle 2 by means of at least one covering device 3, as has been described above by way of example with reference to FIG. 1-13, has the advantage that the vehicle 2 can more easily be located by the vehicle owner, for example in the dark. Likewise, illumination by means of the covering device 3 can also be used to prevent, by means of the illumination, in particular in the dark, another vehicle from not seeing the vehicle mirror, for example, and damaging it when driving past in a narrow street. The same also applies when parking, for example in the dark. Illuminated outlines of the vehicle 2, for example the bonnet, the radiator grill, the roof, the windows, and illuminated functional parts, such as, for example, impact protection strips, and/or illuminated decorative strips, such as, for example, trim strips, can make the vehicle 2 more visible to another vehicle driver, for example when parking in the dark, owing to its at least one illuminated covering device 3. Accidental bumping of the other vehicle can thereby better be prevented.

Although the present invention has been described thoroughly above by means of preferred embodiments, it is not limited to those embodiments but can be modified in a variety of ways. The embodiments shown in FIGS. 1 to 13 can also be combined with one another, in particular individual features thereof.

In particular, the invention is also not limited to the body components shown by way of example in FIG. 1-13. For example, the roof panel shown in FIGS. 3, 4 and 10 to 13 and the side panels on both sides of the vehicle can, for example, be combined to form a continuous or common panel. Likewise, the side panel, for example, can be combined with at least one panel for the A-, B-, C- or D-pillar. The invention is further not limited to the form of the strip element and of the lip elements as shown in FIGS. 1 to 9. The strip element and the lip element can have any form which is suitable for covering at least in part a recess, gap or joint gap in a body component or of two body components. Likewise, the lip element can also be omitted completely if, for example, the at least one light guide is integrated into the strip element.

Furthermore, the covering device 3 can be arranged at any other position on the outside of the vehicle 2 and can be fixed to or integrated with any body component 1, any window, any handle, any decorative element, any functional element, etc. The covering device can further also be in the form of a handle, a decorative element or a functional element. Furthermore, the covering device or at least a part thereof, as has been described above by way of example with reference to FIG. 1-13, can also additionally be designed to illuminate in colour, for example by the use of, for example, coloured LEDs and/or by optionally additionally colouring the at least partially transparent or translucent material of the covering device 3 in order to illuminate the covering device 3 in colour.

The panels mentioned with reference to FIG. 1-13, such as, for example, the side panel, door panel, tailgate panel, wing panel, bonnet panel, tailgate panel, front apron panel, rear apron panel, bumper panel, etc., can be metal panels but likewise, for example, plastics panels or a combination of metal, plastics and fibre reinforced plastics panels, etc. The invention is not limited to metal, plastics and fibre reinforced plastics panels and combinations thereof.

### LIST OF REFERENCE NUMERALS

1 body component
2 vehicle
3 covering device
4 roof panel
5 recess
6 strip element
7 lip element
8 gap
9 lighting device
10 light source
11 light guide
12 side panel
13 opening
14 windscreen
15 rear window
16 A-pillar
17 B-pillar
18 C-pillar
19 D-pillar
20 holder
21 groove
22 fixing portion
23 door panel
24 tailgate panel
25 side window
26 roof rail
27 sunroof
28 bonnet
29 tailgate
30 windscreen
31 rear window
32 protective roof strip
33 wing panel
34 bonnet panel
35 tailgate panel
36 front apron panel
37 radiator grill
38 front bumper panel
39 rear bumper panel
40 rear apron panel
41 vehicle lamp
42 vehicle mirror
43 casing of the vehicle mirror

1. Covering device for covering at least in part a recess, a flat portion, a curved portion and/or a stepped portion of at least one body component and/or a vehicle element of a vehicle, wherein the covering device has a lighting device or can be coupled to a lighting device and wherein the covering device is so designed that light from the lighting device can shine through at least a portion of the covering device.

2. Device according to claim 1, wherein
the covering device has a strip element.

3. Device according to claim 2, wherein
the covering device has on at least one longitudinal side at least one lip element which is fixedly or detachably connected to the strip element.

4. Device according to claim 3, wherein
the at least one lip element is fixed to the strip element integrally or as a separate component and in particular by means of extrusion, adhesive bonding, interlocking and/or clamping.

5. Device according to claim 3, wherein
the strip element has at least one holder for receiving at least one fixing portion of the at least one lip element.

6. Device according to claim 5, wherein
the holder is in the form of a groove with an undercut.

7. Device according to claim 2, wherein
the strip element and/or the at least one lip element are made of a material which is at least partially transparent, translucent or opaque so that light from the lighting device (9) can shine through, wherein the strip element and/or the at least one lip element made of an opaque material has at least one opening for light from the lighting device to shine through.

8. Device according to claim 1, wherein
the lighting device has at least one light source and/or at least one afterglow pigment which is mixed with material of the covering device or is applied to the outside of the covering device as an afterglow ink, afterglow foil or afterglow paint.

9. Device according to claim 8, wherein
the light source is a light-emitting diode, an organic light-emitting diode, an electroluminescent foil, a filament lamp, a halogen lamp, a gas discharge lamp or a laser.

10. Device according to claim 1, wherein
the covering device has at least one light guide, which is integrated into the covering device.

11. Device according to claim 10, wherein
the at least one light guide is integrated into the covering device integrally or as a separate component.

12. Device according to claim 11, wherein
the at least one light guide is extruded or injection moulded into the covering device and/or is arranged in at least one cavity in the covering device.

13. Device according to claim 10, wherein
the light guide can be coupled to the at least one light source, wherein the light guide is in particular an elongate light guide, a light-guiding foil and/or a light-guiding fabric.

14. Device according to claim 1, wherein
the covering device is a decorative element, in particular a trim strip, and/or a functional element, in particular a protective roof strip, roof rail, handle strip or an impact protection strip.

15. System comprising a covering device according to claim 1 and a lighting device.

16. System according to claim 15, wherein
the lighting device has at least one light source and/or at least one afterglow pigment which is mixed with the material of the covering device or is applied to the outside of the covering device as an afterglow ink, afterglow foil or afterglow paint, and wherein the light source is in particular a light-emitting diode, an organic light-emitting diode, an electroluminescent foil, a filament lamp or a laser.

17. System according to claim 16, wherein
the lighting device has at least one light guide which can be coupled to the at least one light source, wherein the light guide is in particular an elongate light guide, a light-guiding foil or a light-guiding fabric.

18. Body component of a vehicle which comprises at least one flat portion, at least one curved portion, at least one stepped portion and/or a recess, wherein the flat portion, the curved portion, the stepped portion and/or the recess is covered at least in part by at least one covering device according to claim 1, and light from a lighting device shines through at least a portion of the covering device.

19. Body component according to claim 18, wherein
the lighting device is part of the body component and/or part of the covering device.

20. Body component according to claim 18, wherein
the body component is a roof panel, a door panel, a wing panel, a bonnet panel, a tailgate panel, a front apron panel, a front bumper panel, a rear bumper panel, a rear apron panel or a side panel of a vehicle.

21. Body component system comprising a first and a second body component,
wherein the first and the second body component together form a recess, in particular a gap or joint gap,
wherein the recess is covered at least in part by at least one covering device according to claim 1, and
wherein light from a lighting device shines through at least a portion of the covering device.

22. Body component system comprising a body component and a vehicle element,
wherein the body component and the vehicle element together form a recess, in particular a joint or joint gap,
wherein the recess is covered at least in part by at least one covering device according to claim 1, and
wherein light from a lighting device shines through at least a portion of the covering device.

23. Body component system comprising a body component and a vehicle element,
wherein the body component or the vehicle element has a recess, a flat portion, a curved portion and/or a stepped portion,
wherein the recess, the flat portion, the curved portion and/or the stepped portion is covered at least in part by at least one covering device according to claim 1, and
wherein light from a lighting device shines through at least a portion of the covering device.

24. System according to claim 22, wherein
the vehicle element is a side window, a sunroof, a glass roof, a windscreen, a rear window, a radiator grill, a vehicle lamp, a vehicle mirror or a vehicle mirror casing.

25. System according to claim 21, wherein
the lighting device is part of at least one of the body components, of at least one vehicle element and/or part of the covering device.

26. System according to claim 21, wherein
the first body component is a roof panel and the second body component is a side panel.

27. Vehicle, in particular motor vehicle, having a body component according to claim 18 and/or a body component system.

28. Vehicle according to claim 27, wherein
the covering device extends in the longitudinal direction of the vehicle and/or in the transverse direction of the vehicle along a recess in the body component or in the body component system.

29. Vehicle according to claim 28, wherein
the covering device extends in the longitudinal direction of the vehicle and/or in the transverse direction of the vehicle along a recess in the first or second body component of the body component system or along a common recess of the first and second body components of the body component system.

30. Vehicle according to claim 29, wherein
the covering device extends in the longitudinal direction of the vehicle and/or in the transverse direction of the vehicle along a recess in the body component or in the vehicle element of the body component system or along a common recess of the body component and of the vehicle element.
